(19) United States
(12) Patent Application Publication
(10) Pub. No.: US 2011/0074687 A1
(43) Pub. Date: Mar. 31, 2011

(54) INFORMATION PROCESSING APPARATUS, INFORMATION PROCESSING APPARATUS CONTROL METHOD, AND STORAGE MEDIUM

(75) Inventors: Hideki Takaoka, Kawasaki-shi (JP); Hitomi Ito, Yokohama-shi (JP)

(73) Assignee: CANON KABUSHIKI KAISHA, Tokyo (JP)

(21) Appl. No.: 12/889,192

(22) Filed: Sep. 23, 2010

(30) Foreign Application Priority Data
Sep. 28, 2009 (JP) 2009-223105

(51) Int. Cl. G06F 3/02

(52) U.S. Cl. 345/168

(57) ABSTRACT

An information processing apparatus control method achieves an improvement in terms of operability for a visually-impaired user, and while doing so, facilitates operation aid by another user. A control method for controlling an information processing apparatus having a display unit equipped with a touch panel, and an operation unit equipped with a hard numeric keypad unit, includes: assigning a function to move a pointer displayed on the display unit, to the hard numeric keypad unit; and effecting control to display a numeric keypad on the display unit in a case where the function to move the pointer is assigned to the hard numeric keypad unit.

### BACKGROUND OF THE INVENTION

1. Field of the Invention

The present invention relates to an information processing apparatus, an information processing apparatus control method, and a storage medium.

2. Description of the Related Art

In an information processing apparatus such as a digital multi-function peripheral (MFP), there is provided a touch panel display unit, which displays graphical user interfaces (hereinafter referred to as “GUI”) for accepting operation by the user, such as soft keys and sliders. This touch panel display unit enables operation through guidance display, etc. as appropriate while switching the requisite GUI display according to the situation, so that it is advantageous in that it can provide the user with many functions in a manner easy to understand.

On the other hand, its flat operation surface makes it rather difficult for a visually-impaired user to judge where to conduct operation. In many cases, a hardware numeric keypad is arranged in the same form in various apparatuses such as a printer, a telephone, and a facsimile apparatus, which makes it easy for a visually-impaired user to recognize its shape, thus facilitating its operation for such a user. Thus, the above-mentioned problem would be mitigated if a visually-impaired user were enabled to give various operational instructions through a numeric keypad.

As discussed, for example, in Japanese Patent Application Laid-Open No. 2005-257973, there is a technique according to which a cursor key function is assigned to a numeric keypad when switching to a voice mode, which gives an instruction to move a pointer through the numeric keypad. Further, as discussed in Japanese Patent Application Laid-Open No. 2003-076475, there is a technique in which when switching to a voice mode, a voice guidance: “Please designate the copying mode” is announced, thus causing the user to select a mode through a numeric keypad.

However, when the operation mode is set to the “voice guidance mode” and a function to move the pointer is assigned to a hardware numeric keypad, it has been impossible to perform numerical input through a numeric keypad. Thus, when the operation mode is the “voice guidance mode,” if another user such as a person with normal eyesight tries to input a value to aid operation, it has been impossible to effect numerical input since a function different from that for numerical input is assigned to the hardware numeric keypad.

### SUMMARY OF THE INVENTION

The present invention is directed to an information processing apparatus having a display unit equipped with a touch panel and an operation unit equipped with a hard numeric keypad unit, including: an assigning unit configured to assign to the hard numeric keypad unit a function to move a pointer displayed on the display unit; and a display control unit configured to control the numeric keypad unit to display the numeric keypad on the display unit in a case where the function to move the pointer is assigned to the numeric keypad unit by the assigning unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating the construction of an image processing apparatus.

FIG. 2 is a plan view illustrating an example of an operation unit shown in FIG. 1.

FIG. 3 is a flowchart illustrating an operation processing method adopted in an information processing apparatus.

FIGS. 4A, 4B, 4C, 4D, 4E, 4F, 4G, 4H, 4I and 4J illustrate examples of GUI displayed on a touch panel display unit.

FIG. 5 illustrates screen control for GUI displayed on a touch panel display unit.

FIG. 6 illustrates a pointer moving processing on a touch panel display unit.

### DESCRIPTION OF THE EMBODIMENTS

Various exemplary embodiments, features, and aspects of the invention will be described in detail below with reference to the drawings. In the example described below, the present invention is applied to an information processing apparatus equipped with a touch panel display unit in which a display unit and a touch input unit are integrated.

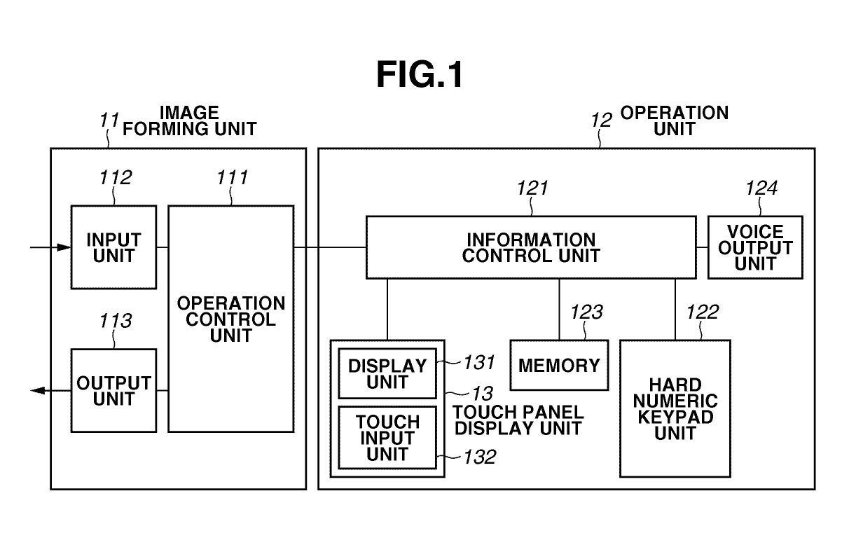

FIG. 1 is a block diagram illustrating the construction of an image processing apparatus according to an exemplary embodiment of the present invention. In the present exemplary embodiment, the information processing apparatus is an image forming apparatus equipped with an operation unit. Examples of the image forming apparatus include a multi-function peripheral (MFP), a scanner, a printer, and a facsimile apparatus. However, the present exemplary embodiment is not restricted to an image forming apparatus but also covers an optional apparatus, etc. connected to an image forming apparatus. Further, the present exemplary embodiment is applicable to any type of information processing apparatus so long as it accepts input of an operation mode designation instruction through a numeric keypad.

In FIG. 1, an image forming unit 11 is equipped with an operation control unit 111, an input unit 112, and an output unit 113. An operation unit 12 is equipped with an information control unit 121, a hard numeric keypad unit 122, a memory 123, a voice output unit 124, and a touch panel display unit 13. The touch panel display unit 13 consists of a display unit 131 and a touch input unit 132 integrated with each other. Here, the information control unit 121 effects a mode switching processing to switch the function of the hard numeric keypad unit 122 based, for example, on whether the operation input mode set is a voice guidance mode or a non-voice guidance mode. When the operation input mode is a voice guidance mode, the information control unit 121 assigns a function to move a pointer, to the hard numeric keypad unit 122. In the case of a non-voice guidance mode, the information control unit 121 assigns a function to perform numerical input, to the hard numeric keypad unit 122.

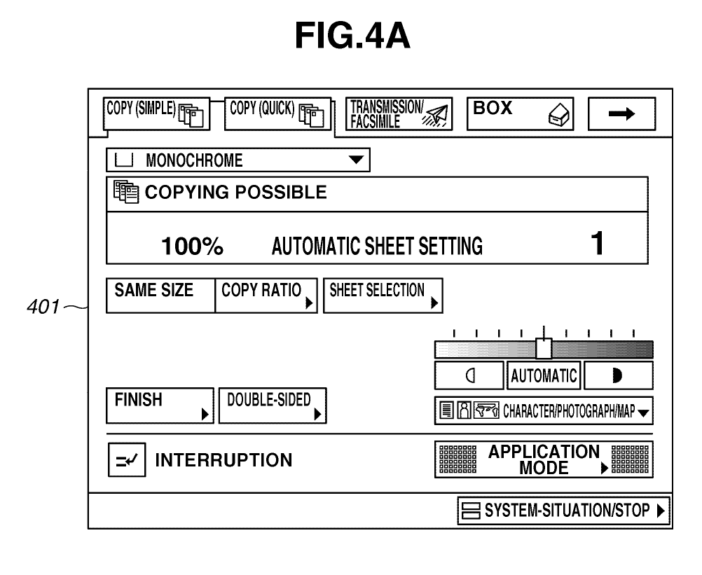

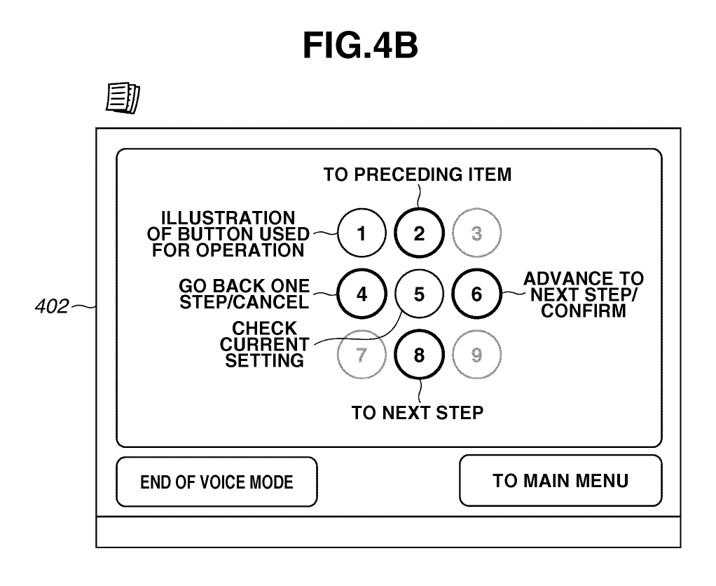

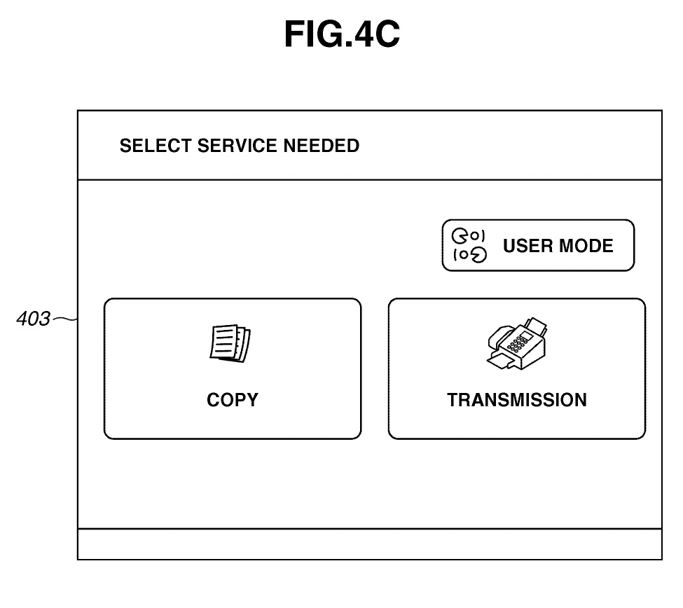

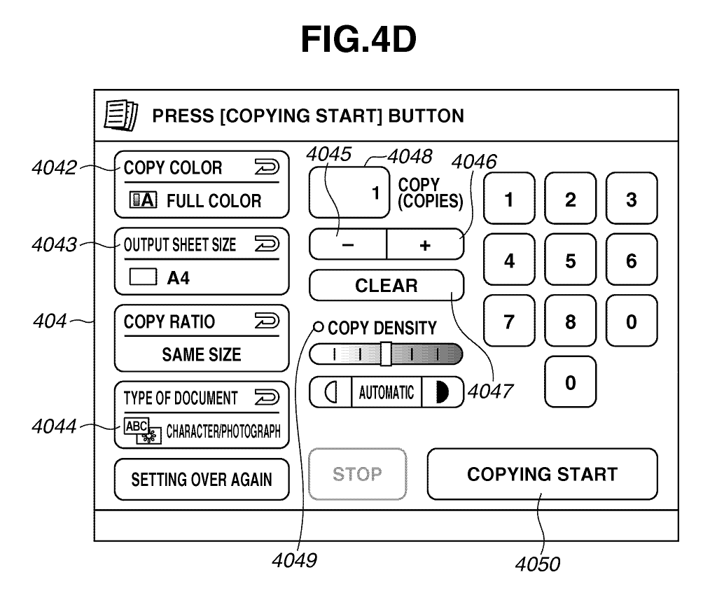

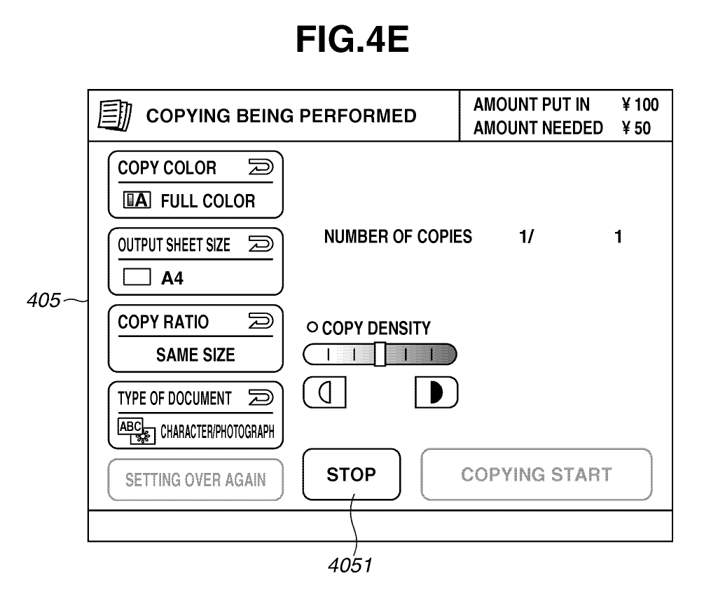

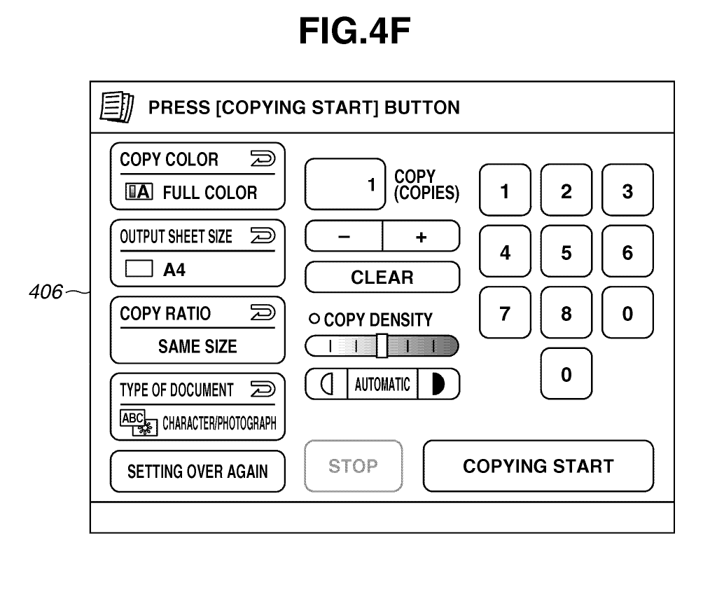

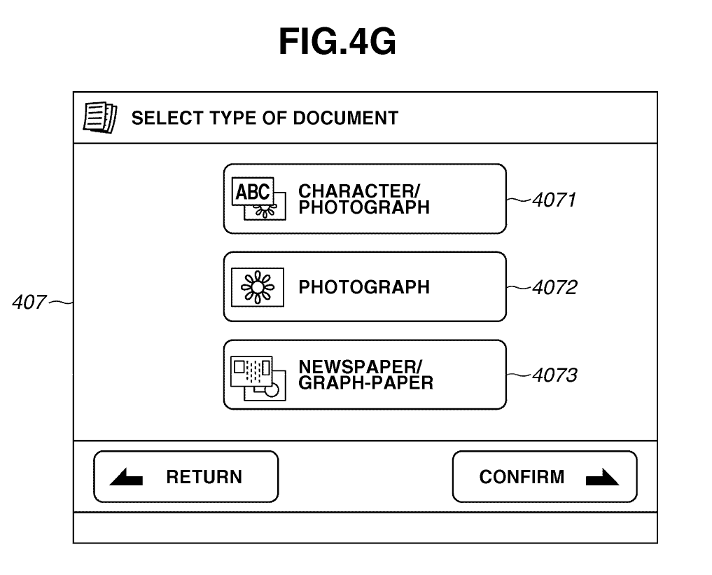

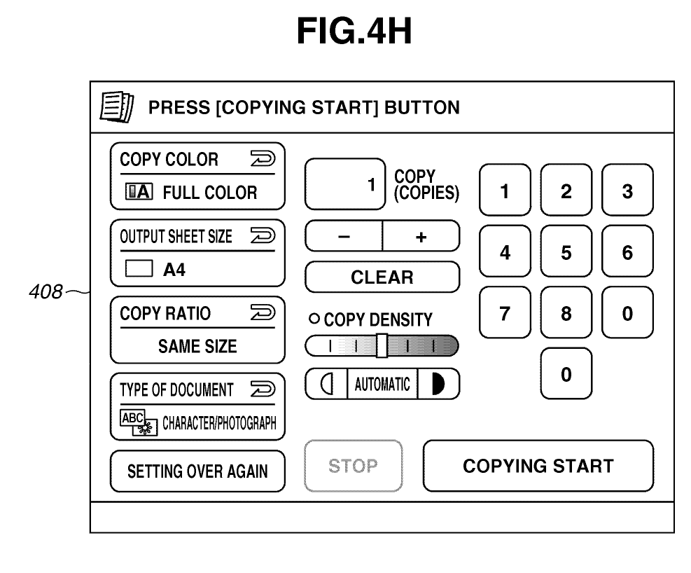

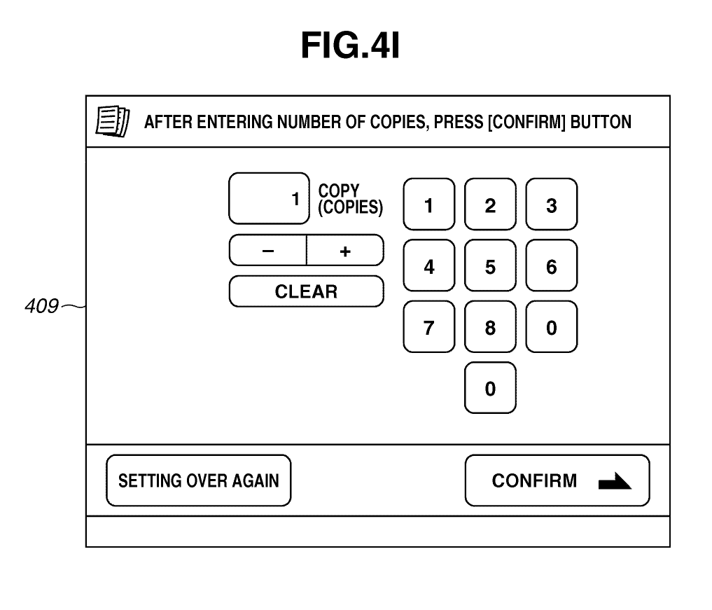

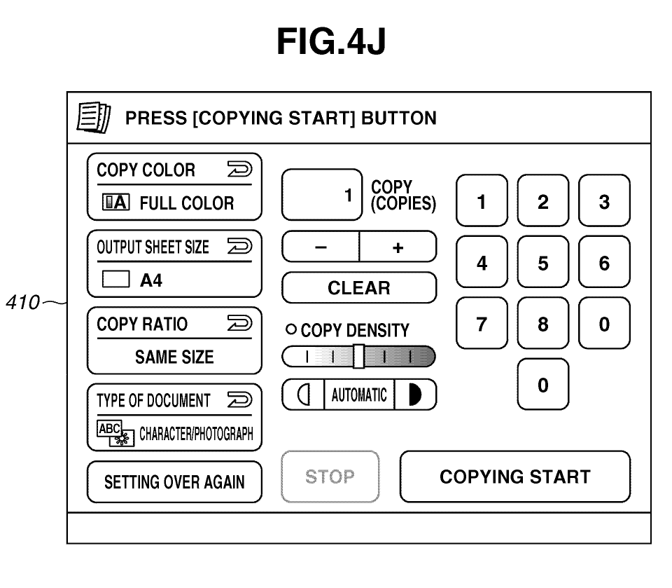

Further, when switching to the voice guidance mode is effected, the information control unit 121 moves the pointer of the display unit 131 according to the key instruction given through the hard numeric keypad unit 122. In this process, the information control unit 121 displays a soft numeric keypad for accepting input of values to be set with the movement of the pointer on the display unit 131 as indicated at 404 and 410 of FIG. 4.

The configuration, arrangement, etc. of the buttons of the hard numeric keypad 122 can be easily recognized even if the operating user is not a person with normal eyesight. In the present exemplary embodiment, when the user who is not a person with normal eyesight has selected the voice guidance mode and is executing operation, a second user who supports him or her can operate the touch panel display unit to aid the operation.

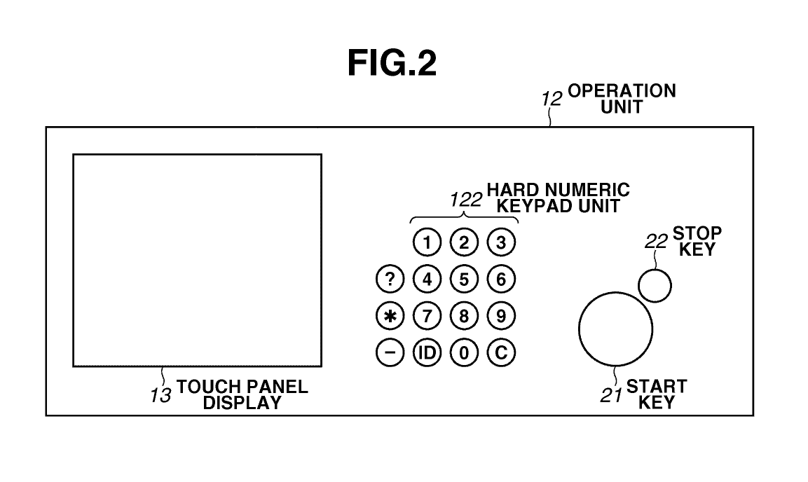

FIG. 2 is a plan view of an example of the operation unit 12 shown in FIG. 1. The arrangement of the hard numeric keypad unit 122 and the touch panel display unit 13 is not restricted to that of the present exemplary embodiment.

In FIG. 2, the operation unit 12 is equipped with the touch panel display unit 13, the hard numeric keypad unit 122, a start key 21, and a stop key 22. The “0” through “9” keys of the hard numeric keypad unit 122 are arranged in the same layout as that of an ordinary numeric keypad with which a printer, a telephone, a facsimile apparatus, etc. are equipped. As a result, it is easy even for a visually-impaired user to discern what key exists at what position on the hard numeric keypad unit 122. For example, once the visually-impaired user grasps the position of the entire hard numeric keypad unit 122, he or she can easily recognize that the “1” key exists in the left upper corner, that the “2” key exists at the uppermost central position, and that the “0” key exists at the lowermost central position.

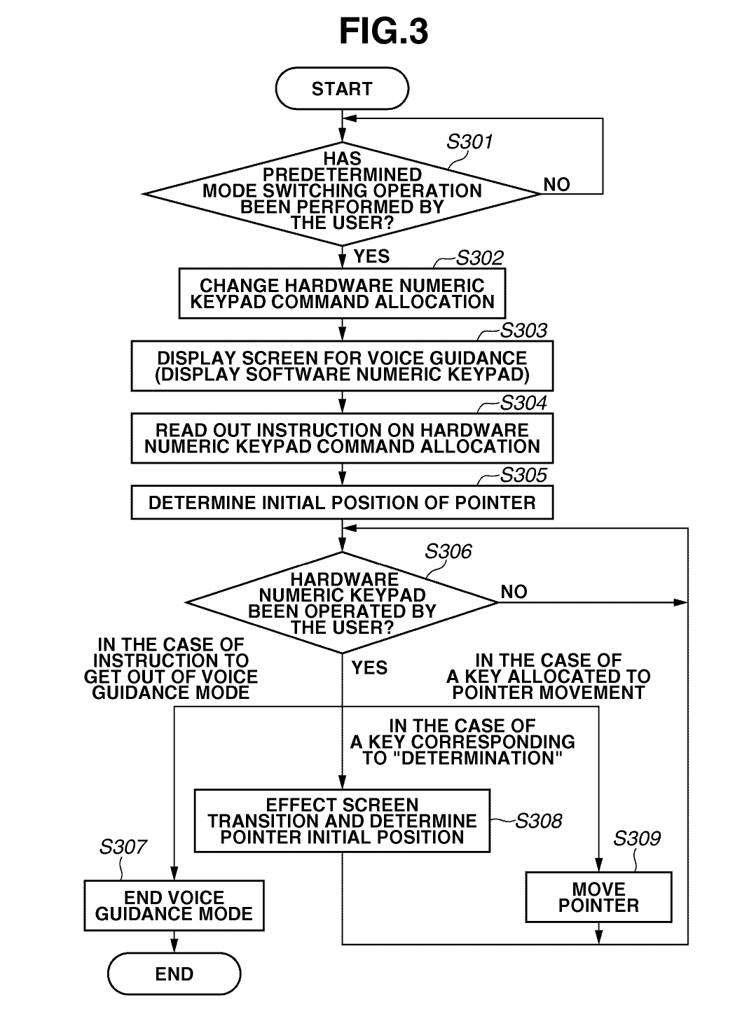

FIG. 3 is a flowchart illustrating an operation processing method adopted in the information processing apparatus of the present exemplary embodiment. In this example, a voice guidance mode is set as the operation mode. More specifically, when the operation mode is switched to the voice guidance mode, a function to move the pointer is assigned to the hard numeric keypad unit 122, and a soft numeric keypad unit for effecting numerical input is displayed on the touch panel display unit. Each of steps S301 through S309 is realized through loading of a control program from a ROM or the like into the memory 123 and through execution of the same by a CPU with which the information control unit 121 is equipped.

When, in step S301, the information control unit 121 detects that switching to the voice guidance mode has been effected by the user based on an instruction given to the operation unit 12, the procedure advances to step S302. The information control unit 121 detects the switching to the voice guidance mode when, for example, a dedicated button (not shown) is pressed. It is also possible to detect the switching to the voice guidance mode when a specific key (e.g., the “0” key) of the hard numeric keypad unit 122 has been kept depressed for a period of time not shorter than a predetermined period of time. As compared with the case in which a dedicated button is provided, the method in which the switching to the voice guidance mode is effected through a long-time depression of a specific key of the hard numeric keypad unit 122 is more advantageous in that it is easier for a visually-impaired user to recognize the button for effecting switching to the voice guidance mode.

In step S302, the information control unit 121 assigns a function to move the pointer, to the hard numeric keypad unit 122. Before the assignment of the function to move the pointer to the hard numeric keypad unit 122, its proper function, i.e., the function to input values is assigned to the hard numeric keypad unit 122.

Next, in step S303, the information control unit 121 displays a screen for a voice guidance mode including a soft numeric keypad on the touch panel display unit 121. And, in step S304, the information control unit 121 outputs, in the form of a voice, a guidance regarding the assignment of the command concerned via the voice output unit 124.

Further, in step S305, the information control unit 121 determines the initial position of the pointer with respect to the GUI displayed on the touch panel display unit 13. For example, the pointer is set to one of a plurality of selection object items displayed on the touch panel display unit 13. Although in this example the pointer is displayed as one encircling the region of a selection object item, it is also possible to adopt some other form of display so long as the current selection object item can be specified. For example, the display may be in the form of an arrow, or the display may be effected such that the color of the object of operation is changed. Next, when, in step S306, the information control unit 121 detects that the hard numeric keypad unit 122 has been operated by a visually-impaired user, the key of the numeric keypad that has been depressed is identified.

When, in step S306, the information control unit 121 determines that the key of the numeric keypad that has been operated is the key for moving the pointer, the information control unit 121 moves the pointer displayed on the display unit 131 in step S309, and then the procedure returns to step S306.

On the other hand, when, in step S306, the information control unit 121 determines that one of the keys of the numeric keypad is a “determine” instruction regarding the pointed GUI item, the procedure advances to step S308. And, in step S308, the information control unit 121 displays on the touch panel display unit 13 a screen showing details on the decided selection object item. For example, the information control unit 121 effects transition of the screen of the touch panel display unit 13 as shown in FIG. 4, and determines the initial position of the pointer on the display screen that has undergone transition. Then, the procedure returns to step S306.

On the other hand, when the information control unit 121 determines that operation of one of the keys of the numeric keypad 122 indicates a predetermined instruction to get out of the voice guidance mode, the procedure advances to step S307. The predetermined instruction may be detected, for example, through depression of a dedicated key (not shown). Alternatively, it may be detected through keeping a specific key of the hard numeric keypad (e.g., the “0” key) depressed for a predetermined time or more. And, in step S307, the information control unit 121 assigns to the hard numeric keypad unit 122 its proper function to input values, and displays on the touch panel display unit a screen for a non-voice guidance mode, with which the voice guidance mode is ended.

In the control of the present exemplary embodiment described above, the soft numeric keypad is displayed in step S303, and from that onward, the display is continued until the voice guidance mode is ended in step S307. However, the operation is not limited to this. It is also possible to previously determine whether the soft numeric keypad is to be displayed or not for each selection object item, effecting display/non-display switching of the soft numeric keypad according to this rule. For example, when the selection object item is one requiring numerical input, the soft numeric keypad is displayed, and, when the selection object item is one not requiring numerical input, no soft numeric keypad is displayed.

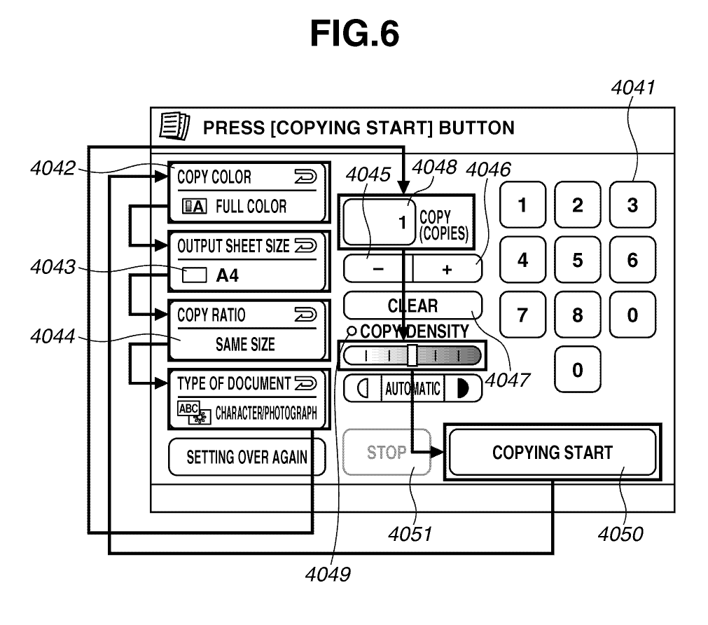

FIG. 4A to 4J illustrate examples of the user interface displayed on the touch panel display unit 13 shown in FIG. 2. In these examples, the transition of the screen displayed on the display unit 131 corresponds to the operation of the hard numeric keypad unit 122 by the user. Further, in the present exemplary embodiment, when the apparatus is in the voice guidance mode, there is executed a display control in which the operation instruction related to the numeric keypad operation is also displayed on the touch panel display unit 13. This assumes that some other user than the user performing operation in the voice guidance mode, who, in this example, is a person with normal eyesight, aids the operation of the user performing operation in the voice guidance mode. Thus, in the case of the touch panel display unit 13 of the present exemplary embodiment, when a key corresponding to an instruction from the user performing operation in the voice guidance mode, for example, a number key of the hard numeric keypad unit 122, is depressed, the information control unit 121 executes the pointer display control shown in FIG. 6.

Here, the pointer shows, in the voice guidance mode, the GUI items which are the selection object item in correspondence with the depression of a button of the hard numeric keypad. In the screen transition control, in a case in which numerical input is accepted with respect to the pointed user interface, the information control unit 121 executes control to display the soft numeric keypad on the display unit 131.

In FIG. 4A, numeral 401 indicates an example of the display screen when the apparatus is in the non-voice guidance mode. When, for example, an instruction from the user to switch to the voice guidance mode is received through a predetermined operation, the information control unit 121 effects transition of the screen from the display screen 401 to a display screen 402.

The display screen 402 illustrates the functions assigned to the keys when the function to move the pointer is assigned to the hard numeric keypad unit 122. At this time, the functions assigned to the keys is illustrated by output via the voice output unit 124. Thus, a visually-impaired user can recognize the roles of the keys assigned to the hard numeric keypad unit 122 as audio information.

In many cases, in different types of apparatuses, such as a printer, a telephone, and a facsimile apparatus, the hard numeric keypad unit 122 is arranged in the same form. This is for the purpose of enabling a user with insufficient eyesight to easily recognize the key arrangement and to perform operation easily by directly feeling by hand the asperity features of the hard numeric keypad unit 122.

Here, the user operates the “2” key or the “8” key of the hard numeric keypad unit 122, moving the pointer between “End of Voice Mode” and “To Main Menu.” The “6” key of the hard numeric keypad functions as a determining key. When the “6” key is depressed by the user, it is determined that there has been given an instruction to select the item being pointed. When “To Main Menu” is selected by the user, the information control unit 121 effects transition of the screen to a display screen 403.

The display screen 403 is a screen for allowing the user to select and designate the function of the information processing apparatus between “Copy” and “Transmission.” In the display screen 403, the pointer moves between “Copy” and “Transmission.” The user moves the pointer by depressing the “2” or “8” key of the hard numeric keypad. When the information control unit 121 determines that “Copy” has been selected and designated by the user, the information control unit 121 effects transition of the screen to a display screen 404.

The display screen 404 is a copy setting screen displayed when the information processing apparatus is in the voice guidance mode and the key of the hard numeric keypad unit 121 to move the pointer has been selected. This copy setting screen is displayed to allow the user to set the various values (number of copies, density, size, etc.) for effecting copying (i.e., the copying of a document).

The display screen 404 is provided with various soft numeric keys. The user touches the soft numeric keys on the touch panel display unit 13, whereby the value of the number of copies, etc. are input. Further, a button 4042 for “Copy Color,” a button 4043 for “Output Sheet Size,” and a button 4044 for “Type of Document” are also GUIs on the touch panel display unit 13. Similarly, a “−” button 4045, a “+” button 4046, and a “Clear” button 4047 are also GUIs on the touch panel display unit 13. When these buttons are touched by the user, the corresponding setting screens are displayed, and setting is effected.

Further, in this example of GUI, the pointer moves between the “Copy Color” button 4042, the “Output Sheet Size” button 4043, the “Type of Document” button 4044, the “Number of Copies” button 4048, the “Copy Density” button 4049, and the “Copying Start” button 4050. That is, when the “2” key or the “8” key of the hard numeric keypad is depressed by the user, the information control unit 121 moves the pointer displayed on the touch panel display unit 13.

When the “6” key of the hard numeric keypad is depressed by the user, it is determined that there has been given an instruction to select the item being pointed at that time. When, for example, the “Copying Start” is selected by the user, the information control unit 121 effects transition of the screen to a display screen 405. More specifically, the information processing apparatus can accept operation by the user through touching of the touch panel display unit 13 and through depression of a key of the hard numeric keypad unit 122. When the “Copying Start” instruction is given, the information control unit 121 gives an instruction to start copying to the operation control unit 111. The operation control unit 111 reads the document, and effects control so as to print the image data of the document.

A display screen 405 is a screen displayed while the information processing apparatus is performing copying. In the display screen 405, the pointer is at a “Stop” button 4051. Thus, the information control unit 121 accepts the depression of the hard numeric key “6” by the user, as an instruction to select a “Copying Stop” command. After the completion of the copying operation, the information control unit 121 displays a display screen 406 on the touch panel display unit 13.

The display screen 406, displayed by the information processing apparatus, is similar to the display screen 404. When the user selects and designates “Type of Document” through the display screen 406, the information processing apparatus displays a display screen 407 on the touch panel display unit 13.

The pointer moves between a “Character/Photograph” button 4071, a “Photograph” button 4072, and a “Newspaper/Graph-paper” button 4073. In this way, the pointer can be moved when the user depresses the “2” key or the “8” key of the hard numeric keypad.

Further, in the present exemplary embodiment, when the display screen 407 is being displayed, a “Confirm” command is assigned to the “6” key of the hard numeric keypad, and a “Return” command is assigned to the “4” key of the hard numeric keypad.

Thus, suppose it is determined that the information processing unit 121 has accepted the depression of the “6” key or the “4” key of the hard numeric keypad by the user. In the case of the “6” key, the set value (one of “Character/Photograph,” “Photograph,” and “Newspaper/Graph-paper”) being pointed at that time is reflected. On the other hand, when it is determined that the information control unit 121 has accepted the depression of the “4” key, the information control unit 121 does not reflect the set value being displayed, and transition to a display screen 408 is effected.

The display screen 408, which is similar to the display screens 404 and 406, is a screen through which the information processing apparatus allows the user to set the various values (number of copies, density, size, etc.) for effecting copying (the copying of a document).

A display screen 409 is a screen the information processing apparatus displays on the touch panel display unit 13 when the user selects and designates the “number of copies” through the display screen 408. This screen is displayed mainly for the purpose of allowing a user with normal eyesight to perform numerical input through the touch operation of GUI items without using the hard numeric keypad.

When the display screen 409 is being displayed, the information control unit 121 of the information processing apparatus assigns the “Increase the number of copies by one” command (function) and the “Reduce the number of copies by one” command (function), for example, to the “8” key and the “2” key, respectively, of the hard numeric keypad. When the number of copies is 1, no further reduction is effected.

When the information control unit 121 accepts the depression of the “2” key or the “8” key by the user, the value of the number of copies set at that time is read out through voice output from the voice output unit 124.

Further, the information control unit 121 assigns the “confirm” command and the “return” command to the “6” key and the “4” key, respectively, of the numeric keypad.

In the display screen 409, the pointer moves to none of the GUI items, and it is impossible for the user to select and designate a GUI item through the hard numeric keypad. When the information control unit 121 accepts the depression of the “6” key or the “4” key of the hard numeric keypad by the user, and, in particular, when it is determined that the depression of the “6” key by the user has been accepted, the information control unit 121 reflects the value of the number of copies set at that time. When it is determined that the depression of the “4” key by the user has been accepted, the setting is not reflected, and the display screen of the touch panel display unit 13 is changed to a display screen 410.

The display screen 410 is similar to the display screens 404, 406, and 408. The numerical keypad displayed on the display screens 404, 406, and 408 is used to input the number of copies. For example, when the “3” soft key is touched in a state in which one of the display screens 404, 406, 408, and 410 is being displayed, the information control unit 121 sets the number of copies to 3.

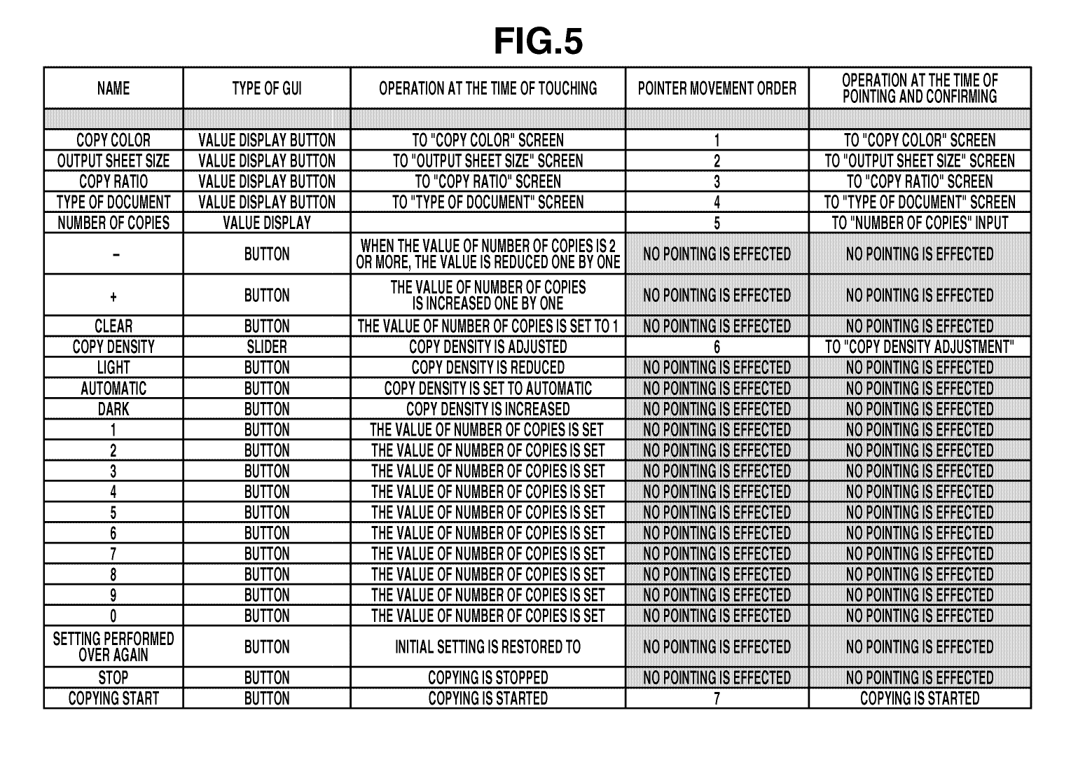

FIG. 5 is a diagram illustrating operations to be executed through screen control of the GUIs displayed on the touch panel display unit 13 of the operation unit 12 shown in FIG. 2. The information control unit 121 is capable of identifying the selection object item to be pointed according to a previously set movement order described below.

In this example, the GUI items (selection object items) displayed on the display screen 404 (or the display screen 406, 408, or 410), i.e., names, type of GUI, operation at the time of touching, pointer movement order, operation at the time of selection/designation during pointing, are classified into an operation table.

In FIG. 5, the “type of GUI” is also referred to as Widget. The types of GUI include virtual buttons, sliders, etc. Here, the “value display button” displays on the surface of a virtual button the current set value of the item to be operated through touching of the button, and the “value display” displays the current set value. The “pointer movement order” indicates the order in which the pointer is moved from the current pointing position to another position when the “2” key or the “8” key of the hard numeric keypad is depressed by the user in the voice guidance mode.

In the display screen 404, the initial position of the pointer is the “Copy Color.” When the hard numeric key “8” to which the command to “advance the pointer in the forward direction” is assigned is depressed, the pointer moves to the “output sheet size.” When the hard numeric key “8” is depressed, the pointer position is successively changed to the GUI types constituting the pointer movement objects: “copy ratio,” “type of document,” “number of copies,” and “copying start.”

When, with the final GUI “copying start” being pointed, the hard numeric key “8” is depressed, returning to the initial GUI “copying start” is possible. As a result, even in a case in which the pointer has passed a desired GUI type, it is possible to effect pointing at the desired type of GUI again by repeatedly depressing the same key.

When the hard numeric key “2” to which the command: “return the pointer in the opposite direction by one step” is assigned is depressed, the pointer moves in a direction opposite to that in the case of the “8” key. Through a combined use of the hard numeric keys “8” and “2”, it is possible to move the pointer to a type of GUI desired by the user.

Further, in the present exemplary embodiment, setting is made such that no pointing is effected with respect to the soft numeric keys, the + key, the − key, the “clear” key, the “setting performed over again” key, the “stop” key, the “dark” key, the “automatic” key, and the “light” key. Apart from this, it is also possible for the user to perform setting through the operation unit 12 as to whether each selection object item is to be pointed or not. The selection object items set not to be pointed are skipped at the time of pointer movement, and are not pointed. As a result, in a case in which the number of selection object items displayed on the display unit 13 of the touch panel unit is large, it is possible to reduce the requisite time for moving the pointer.

FIG. 6 illustrates the pointer movement processing on the touch panel display unit 13 shown in FIG. 2. In this example, when the hard numeric key “8” or “2” is depressed, the pointer is successively moved with regard to the GUI types constituting the pointing objects. The buttons that are the same as those of FIG. 4 are indicated by the same reference numerals and a description thereof will be omitted. When the information control unit 121 accepts the depression of the key corresponding to the “8” key of the hard numeric keypad unit 122 of the operation unit 12, the pointer on the touch panel display unit 13 moves in the order of the arrow in FIG. 6. When the hard numeric key “2” is depressed, the pointer moves in an order reverse to the arrow.

In the information processing apparatus of the present exemplary embodiment, when the pointer is moved through numeric keypad operation in the case in which the voice guidance mode is set, the soft numeric keypad unit does not constitute the object of the pointer movement. Thus, higher priority is given to items related to function setting in performing pointing, whereby the pointer is moved smoothly to buttons other than the soft numeric keys in the GUI.

According to the present exemplary embodiment, even when the hard numeric keypad, which is an operation unit for proper numerical input, is used as the key for moving the pointer, there is executed a control to display the soft numeric keypad as the GUI on the touch panel screen in correspondence thereto.

Thus, a person with normal eyesight can perform numerical input by touching the soft numeric keypad. Thus, it is possible to provide an information processing apparatus, such as a digital multi-function peripheral, which enables a person with normal eyesight to aid a visually-impaired user trying to operate the apparatus.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-223105 filed Sep. 28, 2009, which is hereby incorporated by reference herein in its entirety.

What is claimed is:

1. An information processing apparatus having a display unit equipped with a touch panel and an operation unit equipped with a hard numeric keypad unit, comprising:
an assigning unit configured to assign to the hard numeric keypad unit a function to move a pointer displayed on the display unit; and
a display control unit configured to control the display unit so as to display the numeric keypad on the display unit in a case where the function to move the pointer is assigned to the numeric keypad unit by the assigning unit.

2. The information processing apparatus according to claim 1, wherein the assigning unit assigns the function to move the pointer, to the hard numeric keypad upon accepting an instruction to operate the information processing apparatus in a voice guidance mode.

3. The information processing apparatus according to claim 1, further comprising:
a moving unit configured to move the pointer displayed on the display unit so as to cause it to trace a plurality of selection object items displayed on the display unit in response to the depression of the hard numeric keypad unit to which the function to move the pointer is assigned by the assigning unit.

4. The information processing apparatus according to claim 3, wherein the moving unit moves the pointer while skipping the selection object items of the plurality of selection object items set not to be pointed.

5. The information processing apparatus according to claim 4, further comprising:
a setting unit configured to set a selection object item not to be pointed.

6. A control method for controlling an information processing apparatus having a display unit equipped with a touch panel, and an operation unit equipped with a hard numeric keypad unit, comprising:
assigning a function to move a pointer displayed on the display unit, to the hard numeric keypad unit; and
effecting control to display a numeric keypad on the display unit in a case where the function to move the pointer is assigned to the hard numeric keypad unit.

7. A computer readable storage medium for storing a computer program for controlling an information processing apparatus having a display unit equipped with a touch panel and an operation unit equipped with a hard numeric keypad unit, the computer program comprising:
a code to assign a function to move a pointer displayed on the display unit, to the hard numeric keypad unit; and
a code to effect control to display a numeric keypad on the display unit in a case where the function to move the pointer displayed on the display unit is assigned to the hard numeric keypad unit.
